(19) United States
(12) Patent Application Publication
(10) Pub. No.: US 2014/0198203 A1
(43) Pub. Date: Jul. 17, 2014

(54) DIAPER RFID TAG AND IMAGE ANALYSIS SYSTEM

(71) Applicant: TECHLP INTERNATIONAL LIMITED, Nicosia (CY)

(72) Inventors: Eyal Dov VARDI, Bet Nir (IL); Dov EHRMAN, Jerusalem (IL)

(73) Assignee: TechlP International Limited, Nicosia (CY)

(21) Appl. No.: 13/742,089

(22) Filed: Jan. 15, 2013

(51) Int. Cl. G08B 21/20

(52) U.S. Cl. CPC G08B 21/20
USPC 348/135

(57) ABSTRACT

A diaper analysis system includes a test strip disposed on an inner layer of a diaper. A housing attachable to the diaper at an outer edge of the diaper includes an imager oriented toward a portion of the test strip when attached to the diaper. The imager is configured to obtain an image of a portion of the test strip and a transmitter is configured to transmit a test result to a remote computing resource.

### FIELD

The technology herein generally relates to diapers, test strips usable in diapers, and systems for analyzing a test strip in a diaper.

### BACKGROUND AND SUMMARY

Test strips are useful tools that can give ordinary (or professional) people meaningful information on the current condition of their body. For example, a test strip that is impregnated with certain chemicals changes color when urine, blood, or some other substance comes into contact with the strip. Some test strips are designed to have multiple different test “portions” on the strip with each portion having a different chemical impregnation so as to provide different types of information to a user. For example, a single test strip may test protein, hormone, glucose, and PH levels of the user. To differentiate between the tests, each portion is set to turn to a specific color should the concentration of the substance in question exceed a given amount.

Traditionally, these types of tests are carried out by placing the liquid of the person into a container and submerging the test strip into the container. However, this type of laboratory environment may be relatively inefficient (or messy) for the persons performing the tests or that are the subject of the tests. Thus, it will be appreciated that new and interesting techniques in this area are continually sought.

In certain example embodiments, a diaper tag is provided with an RFID (radio frequency identification) device that clips, clamps, or otherwise is configured to attach to a diaper. The diaper includes a test strip (which might be a part of and/or pre-applied to the diaper tag) that is disposed upon an inner surface of the diaper. The diaper tag includes a lens, camera, scanner that is configured to obtain an image of at least a testing area or portion of the test strip.

In certain example embodiments, the camera (e.g., scanner) from the diaper tag is located “outside” of the diaper while the test strip is “inside” the diaper. In certain example embodiments, the test strip is placed so as to extend beyond an edge of the diaper. The diaper tag is placed in accordance with the placement of this portion of the test strip. In other words, the diaper tag may be place such that it is configured to optically communicate with a portion of the test strip.

In certain example embodiments, a conventional test strip may be combined with a conventional diaper. An example diaper tag may then be attached to the diaper to acquire information from the test strip. In certain example embodiments, the diaper tag may be built into the diaper. The test strip also includes a testing portion where chemical tests are performed (e.g., by combining a liquid and impregnated chemical compositions). The test strip may include two conductive lengths that short when bridged by a liquid (e.g., urine) or other substance. This “closed” circuit may be detected and thereby trigger the acquisition of the test strip test results (e.g., by a camera or scanner).

### BRIEF DESCRIPTION OF THE DRAWINGS

These and other features and advantages will be better and more completely understood by referring to the following detailed description of exemplary non-limiting illustrative embodiments in conjunction with the drawings of which:

FIG. 1 is a front perspective view showing a diaper with a test strip and an attached diaper tag according to certain example embodiments;

FIG. 2 is another front perspective view of a diaper according to certain example embodiments;

FIG. 2A is an exploded view showing an example test strip;

FIG. 2B shows illustrative views of example test strips;

FIGS. 3A-3B are rear perspective views of a diaper according to certain example embodiments;

FIG. 4A is a rear perspective view of another example embodiment of a diaper;

FIG. 4B is a close-up view of a portion of the example diaper, test strip, and diaper tag of FIG. 4A;

FIG. 5A is a perspective view of an example diaper tag according to certain example embodiments;

FIG. 5B is a view of a back portion of the example diaper tag of FIG. 5A;

FIG. 5C is a side view of the example diaper tag of FIG. 5A in a closed position;

FIG. 6A is a perspective view showing the example diaper tag of FIG. 5 with an example test strip;

FIGS. 6B and 6C show examples test strips with multiple testing areas according to certain example embodiments;

FIG. 7 is a perspective view of another example diaper tag;

FIG. 8A is a block diagram of an example diaper tag and test strip;

FIG. 8B is a block diagram of a diaper tag according to certain example embodiments;

FIG. 9 is a flow chart of an example process for acquiring a test result from a test strip according to certain example embodiments;

FIG. 10 is a flow chart of an example process for processing a test result according to certain example embodiments; and

FIG. 11 is a block diagram of an example computing system according to certain example embodiments.

### DETAILED DESCRIPTION

The following description is provided in relation to several example embodiments that may share common characteristics and/or features. It is to be understood that one or more features of any of the embodiments may be combinable with one or more features of other example embodiments. In addition, any single feature or combination of features in any of the embodiments may constitute an additional embodiment.

The example embodiments described herein may relate to diapers, test strips, and/or diaper tags for acquiring images of a test strip. The diaper tag may communicate (e.g., wirelessly) to a remote computing resource where the test results may be further processed.

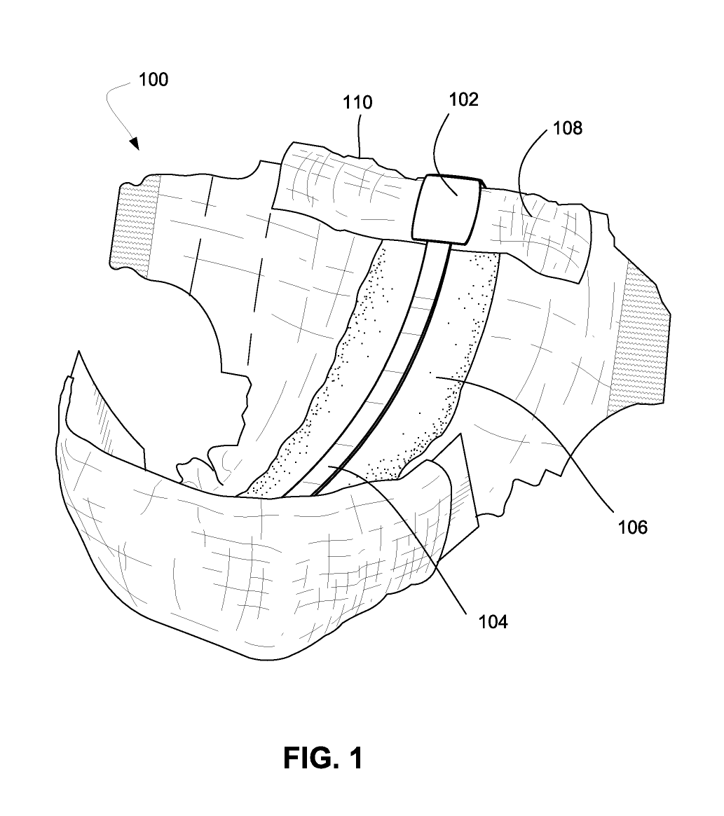

FIG. 1 is a front perspective view showing a diaper with a test strip and a diaper tag according to certain example embodiments. Diaper 100 may be formed out of a cloth-like (e.g., cotton, microfiber, etc) and/or a disposable material (e.g., polymer based). It will be appreciated that diapers may be differently sized for a comfortable fit depending on the wearer (e.g., babies, adults, etc).

A test strip 104 is disposed inside of the diaper 100 on inner portion 106 that generally extends longitudinally from the front to the back of the diaper 100. A proximal end of test strip 104 is positioned at or near the back end of the diaper 100 at rear edge 110. The test strip 104 may be divided between a portion that is covered by the diaper tag 102 (a testing portion or area) and an exposed portion. Generally, the portion of the test strip 104 that is exposed is made out of a liquid absorbing material (e.g., paper) that communicates the liquid to the testing area (portion) of the test strip. Once the liquid reaches this test area the chemically impregnated pieces of the test strip react to the liquid to thereby produce a test result.

The diaper tag 102 attaches to the diaper at rear edge 110 and covers the testing portion of the test strip 104 and some of diaper reinforced area 108.

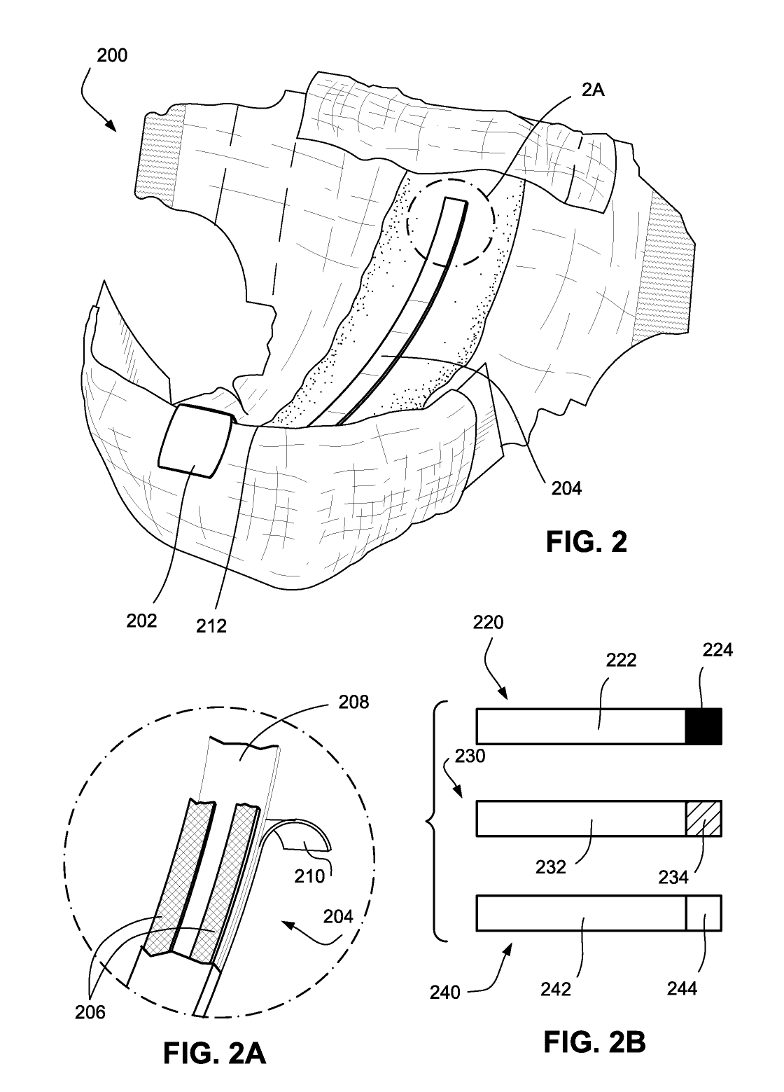

FIG. 2 is another front perspective view of a diaper according to certain example embodiments. Diaper 200 includes a test strip 204 that is disposed along an inner portion of the diaper 200. However, unlike FIG. 1, diaper tag 202 is attached over front edge 212 of diaper 200. Additionally, the proximal portion or end of the test strip 204 extends to or near front edge 212. Accordingly, the test area of the test strip 204 is disposed at the front part of the diaper with the attached diaper tag 202.

FIG. 2A is an exploded view showing an example test strip. Test strip 204 may include electrically conductive lengths 206 that run most or all of the length of test strip 204. The conductive lengths 206 may initially present an open circuit. However, when bridged by a liquid (e.g., urine) or other substance, they are effectively short circuited. This short circuiting may then be detected by the diaper tag and be indicative of activation or completion of one or more tests on test strip 204. Specifically, when the conductive lengths 206 are exposed to a liquid they become conductively coupled—possibly even short out. Such conduction (e.g., a short) may be detected by an attached diaper tag that is conductively connected to the conductive lengths 206.

The test strip 204 may also include liquid absorbing material 208 (e.g., paper) that functions to communicate liquid from a “wet” portion to a drier portion of the test strip 204 that includes the testing area of the test strip. Test strip 204 may include a backing adhesion portion 210 that provides for adhesion to the diaper 200.

FIG. 2B shows illustrative views of example test strips. Test strip 220 includes a first portion 222 to conduct a liquid to testing area 224. Test strip 230 includes a first portion 232 to conduct liquid to test area 234 and test strip 240 has a first portion 242 to conduct liquid to test area 244. Each of strips 220, 230, and 240 may have different types of chemicals applied to respective testing areas 224, 234, 244 that are configured to react in different ways to an applied liquid. Thus, one strip may test glucose levels and another may test protein levels. Once a test has been conducted (e.g., the testing area reacts to the liquid) an image of the testing area may be acquired and analysis of the image may be conducted by a processor of the diaper tag.

For test strip 220, a result of analyzing the acquired image may be High—“ABC3233H233B8277.” For test strip 230, the test result may be Medium—“ABC3233H244B8278.” With test strip 240, the test result may be Low—“ABC3233H255B8276.” These results may be saved to a diaper tag RFID chip, for example, as: “<TestID> ABC3233H233B8276</TestID>”. A central server (or other endpoint device may determine that the received string is “high,” “medium,” or “low.” It will be appreciated that other types of status indicators or values may be determined based on the received string.

It will be appreciated that a composite test strip may incorporate two or more testing areas. In other words, all of the testing areas (224, 234, 244) of FIG. 2B may be combined onto one test strip and present a composite multicolored or multi-shape pattern that may be acquired and then analyzed for multiple test results. In certain example embodiments, a diaper tag may be positioned or configured to acquire only some of the testing areas. Thus, for example, if a test strip has 3 test areas, an imager of the diaper tag may acquire an image of just one of the test areas.

In certain examples, the thickness of a test strip may be about ⅛ of an inch. In certain examples, the thickness may be increased towards one end of the test strip. For example, if a test strip is configured to extend beyond the edge of a diaper, the portion of the test strip that extends above or beyond the edge of the diaper may have an increased thickness. This thickness may provide structural stability for this portion of the test strip as it may not be directly supported by the inside surface of the diaper. Accordingly, the portion of the test strip located beyond the edge of the diaper may be structurally stronger than the portions disposed on the inner surface of the diaper. In certain examples, a testing area that optically presents the test results of the test strip may be located on a reverse or underside portion of the test strip. Thus, when a diaper is worn by a person, the testing area may “face” away from the user.

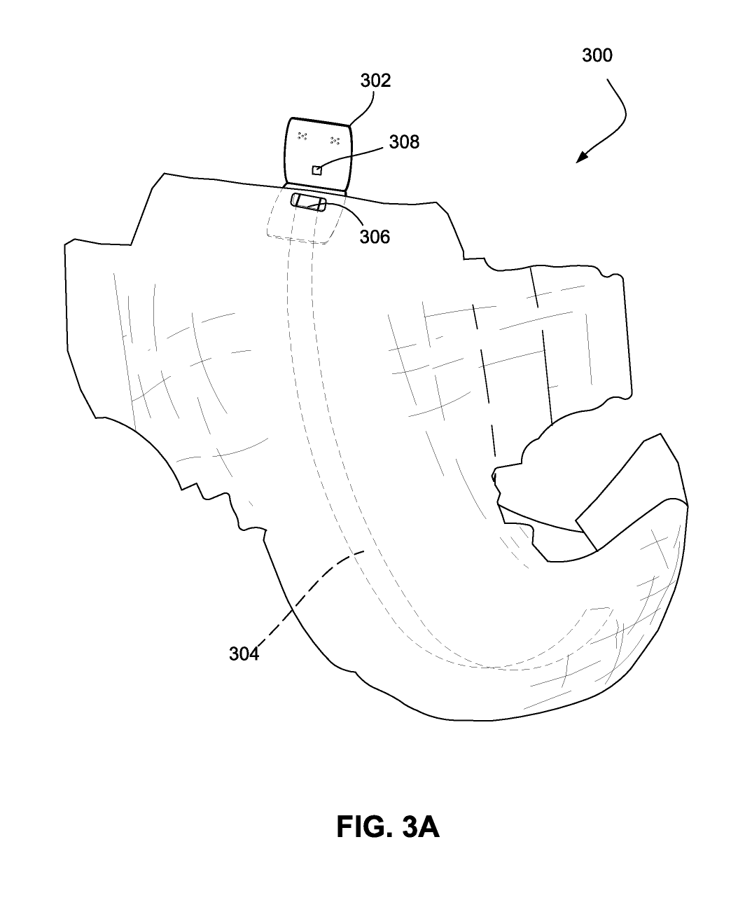

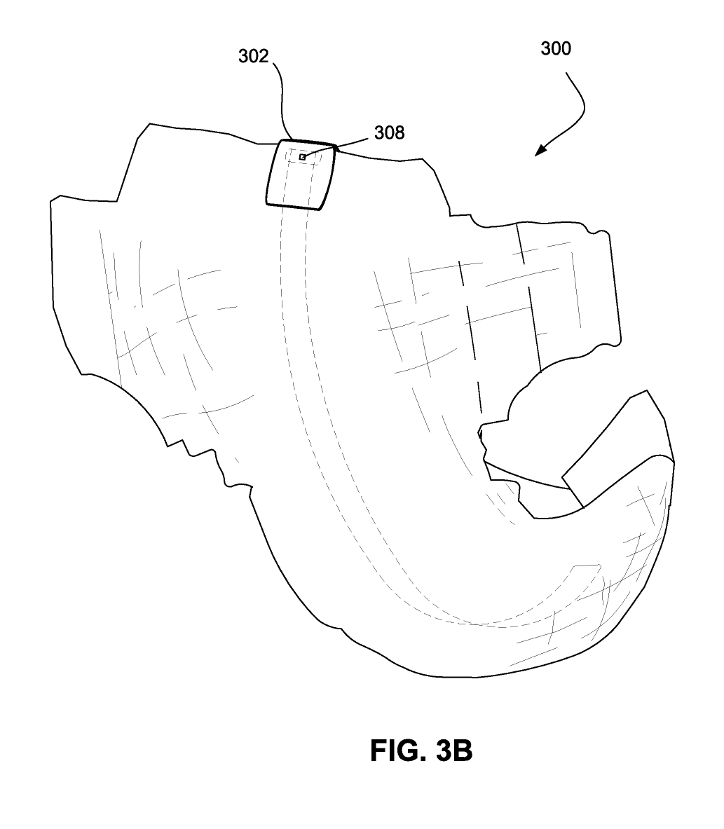

FIGS. 3A-3B are rear perspective views of a diaper according to certain example embodiments. Diaper 300 includes an imaging window 306. The imaging window 306 is positioned so that when the diaper tag 302 is attached to the diaper 300 the imager 308 on the diaper tag 302 can view the test strip 304 through the imaging window 306. In other words, a camera positioned “outside” of the diaper and can view the test strip 304 located “inside” the diaper through the imaging window 306. The diaper tag may be positioned flush against the edge of the diaper 300. However, it will be appreciated that the tag may be configured to adopt other non-flush positions.

In certain examples, an imaging window may be constructed at the time the diaper is manufactured. In certain examples, conventional diapers may be modified by users (e.g., staff at a hospital). In certain examples, a specialized tool may be provided to create the imaging window (e.g., similar to a hole punch).

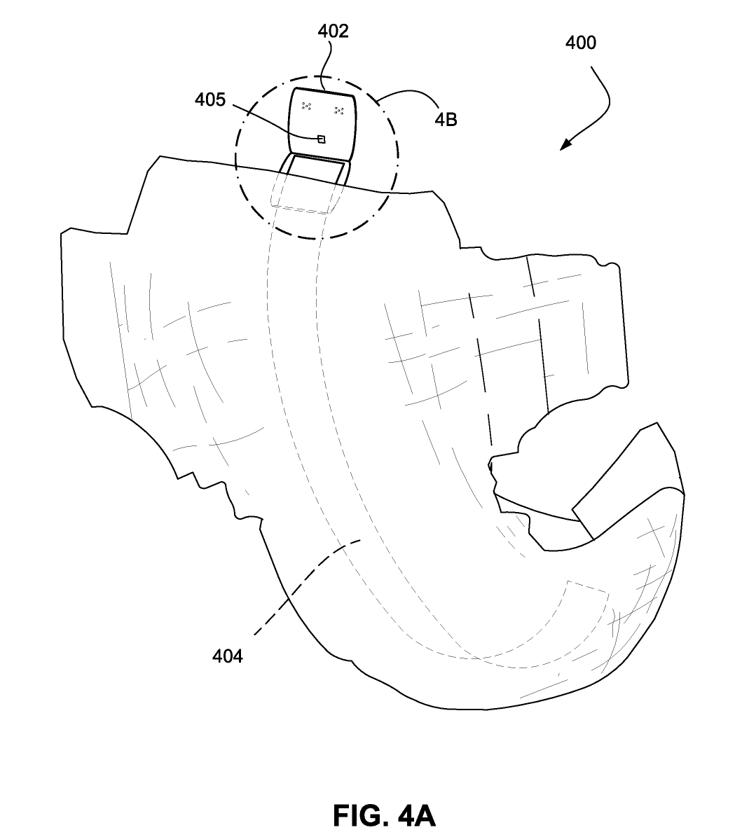

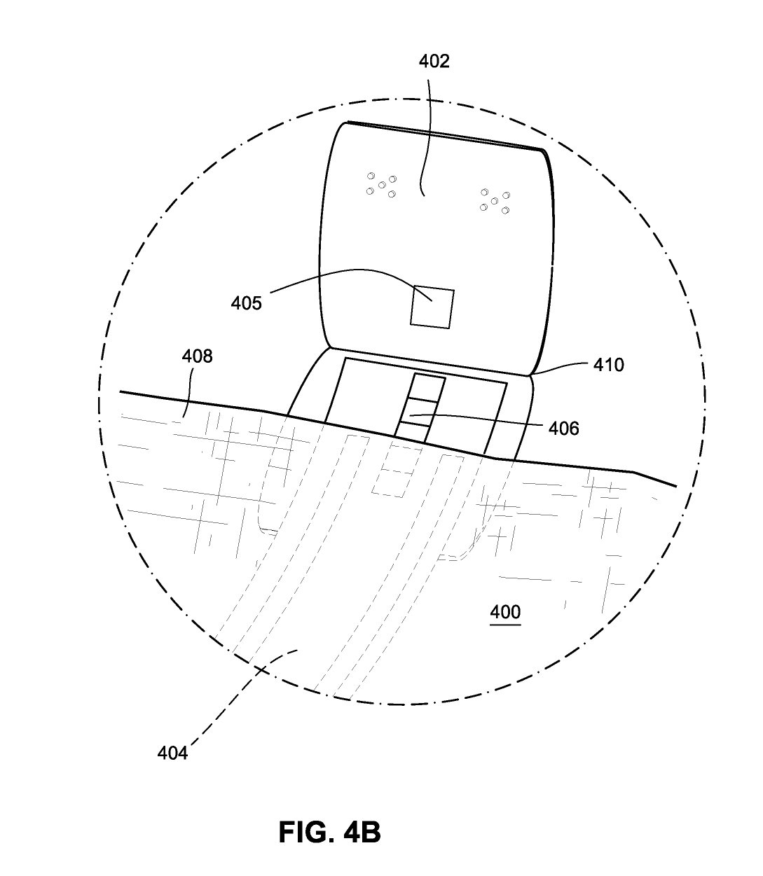

FIG. 4A is a rear perspective view of another example embodiment of a diaper and FIG. 4B is a close-up view of a portion of the example diaper, test strip, and diaper tag of FIG. 4A. In contrast to the flush placement of the diaper tag 302, diaper tag 402 is positioned away from the edge of diaper 400. Specifically, the rotational axis 410 of diaper tag 402 is spaced apart from edge 408 of the diaper 400.

The space between edge 408 and rotational axis 410 includes testing portion 406 of the test strip 404. In this configuration, imager 405 may acquire an image of the test portion 406 without the need to manufacture an imaging window in the diaper.

In certain embodiments, the imager may be a full color optical scanner/reader (e.g., similar to a fingerprint scanner). It will be appreciated that other types of imagers and/or scanners may be used to acquire test information from a test strip. For example, a black and white imager may be used when different shapes correspond to different test results and/or when the results are binary. Additionally, the scanner may have an acquisition window that is wider than the testing portion 406 of the test strip 404. In certain examples, the liquid absorbing material of the test strip may be structured such that it is locked into position by pins that are included with the diaper tag.

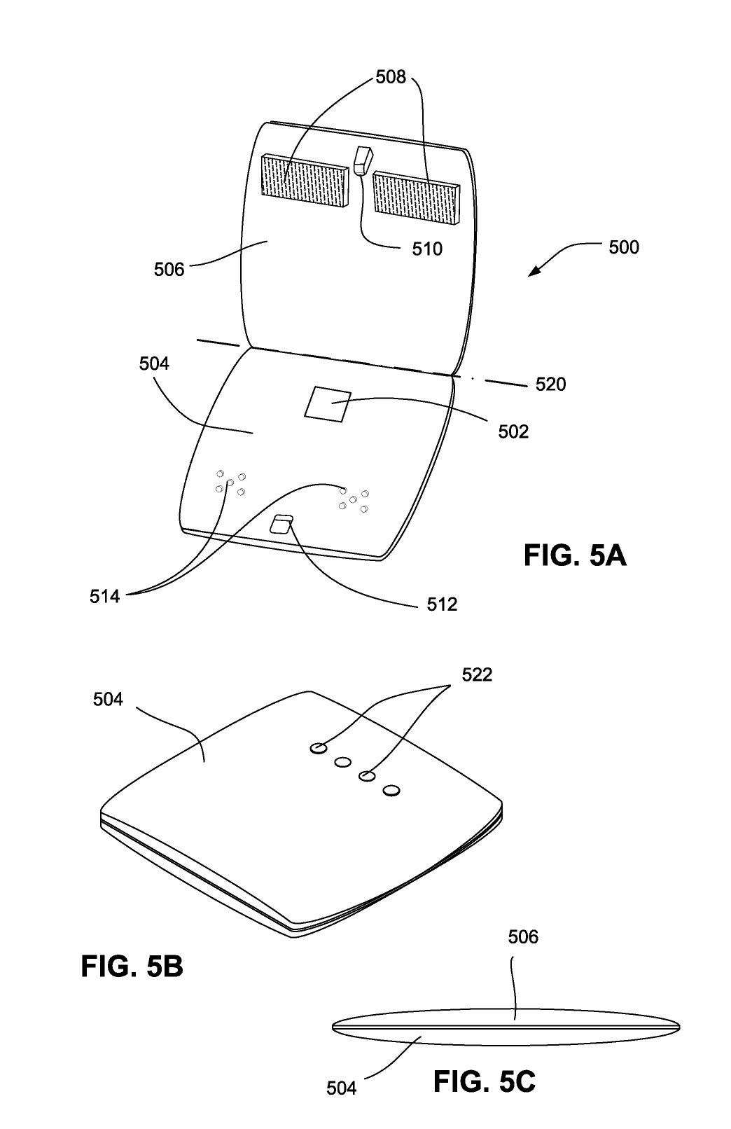

FIG. 5 is a perspective view of an example diaper tag according to certain example embodiments. Diaper tag 500 has a housing or structural body that includes a first portion 504 and a second portion 506. The second portion 506 includes a projection 510 (e.g., a hook) that engages recess 512 (e.g., through the diaper) when the diaper tag is in a closed position. Structurally, this engagement may occur by punching a hole through the diaper or forcing diaper material into the recess 512.

The first portion and second portion rotate with respect to each other about axis 520. For example, second portion 506 may be rotated down to close over first portion 504. In certain example embodiments, portions 504 and 506 may have similar or identical areas. The rotational motion may be supported by a spring loaded clip that may lock when the two portions adopt a certain angle with respect to each other (e.g., 5 degrees). Accordingly, a person may snap, clamp, or clip a diaper tag onto a diaper. In certain example embodiments, the diaper tag may be constructed so as to be water proof. For example, the diaper tag may be cleanable for sterilization purposes.

First portion 504 includes a camera hole 502 from which an imager may acquire an image of a test portion of a test strip. First portion 504 may have a cover that is secured over a cavity (not shown). The cover may be secured via screws, welding techniques (e.g., ultrasonic), adhesives, or the like. The cavity may hold, e.g., a camera, RFID chip, processor (possibly part of the RFID chip), system-on-a-chip, and/or the like. In certain instances, a separate cavity may be supplied for a battery. In certain examples, the portion with the camera, processor, etc is thicker than the “inside” portion without such components. Accordingly, the portion of the diaper tag that is to be placed on the inside of the diaper may be thinner than the other portion of the diaper tag.

FIG. 5B is a view of a back portion of the example diaper tag of FIG. 5A. In certain example embodiments, first portion 504 may be structure to engage the outside of a diaper to which it is attached. Correspondingly, second portion 506 may engage the inside part of the diaper. Embedded in an outer surface of the diaper tag 500 are multiple exposed charging protrusions that are used to connect the diaper tag to a charging station. In other words, the diaper tag 500 may include a rechargeable battery that is charged by connecting the charging protrusions to an appropriate power source. In certain example embodiments, a diaper tag may include a non-rechargeable power source.

In certain example embodiments, the two portions may be physically separate and attachable by snapping the two portions together. In other words, instead of rotating about an axis, the portions may be attachable at a point along the same (or different) area.

FIG. 5C is a side view of the example diaper tag of FIG. 5A in a closed position with first and second portions engaging one another. While the thickness of the two portions is shown to be equal or roughly equal, in certain example embodiments the first portion 504 may be thicker than the second portion 506.

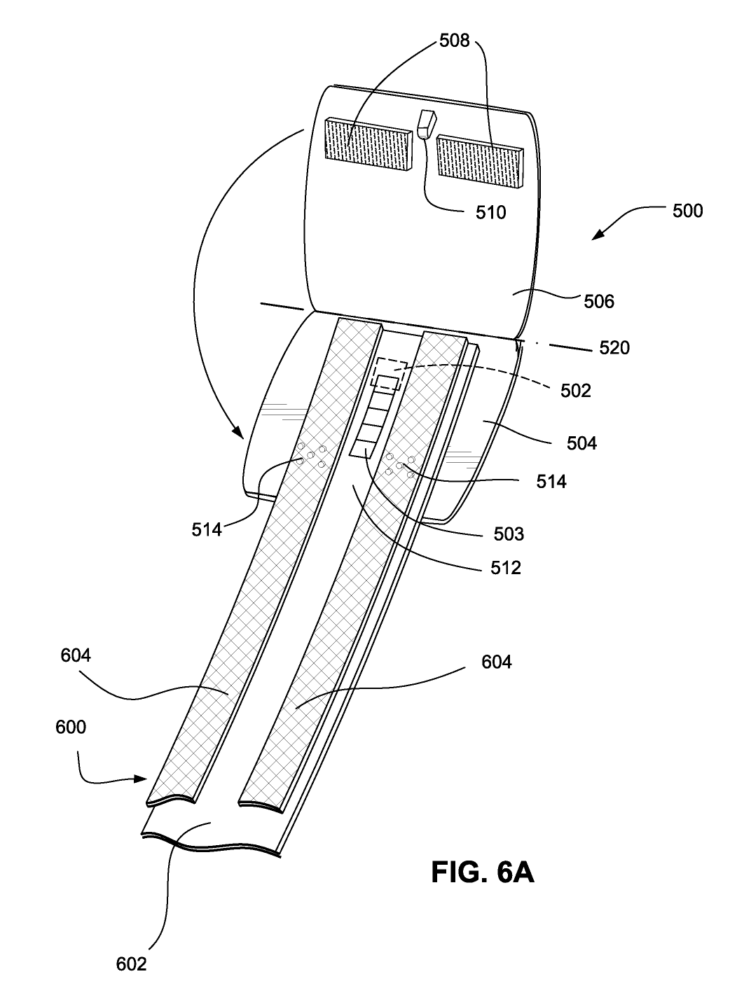

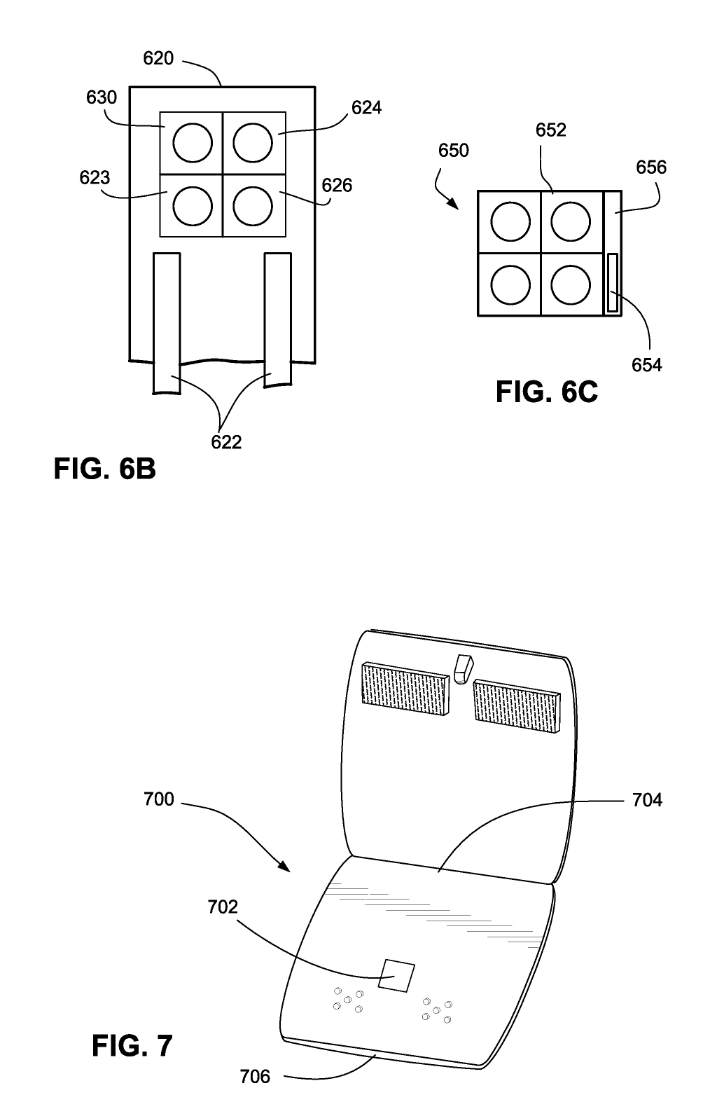

FIG. 6A is a perspective view showing the example diaper tag of FIG. 5 with an example test strip 512 having testing areas 503. Conductive elements 514 of first portion 504 may conductively contact conductive elements 508 of the second portion 506 when the diaper tag 500 is in a closed position. This conductive contact may include a portion of the conductive lengths 604 of test strip 600. Accordingly, when the conductive lengths 604 of the test strip short out due to the presence of a liquid, the diaper tag may determine or detect that a test strip has been activated. In certain examples, conductive elements 514 may contact conductive lengths 604 when the diaper tag is attached to a diaper. Alternatively, conductive elements 508 may contact conductive lengths 604 when the diaper tag is attached to a diaper (e.g., depending on the orientation of the diaper tag). The test strip 600 also includes a liquid absorbing material 602, such as, for example, paper that is configured to communicate liquid to a testing area of the test strip 600 that is located in optical communication with the imager hole 502 and its underlying imager. In certain examples, one side of a test strip may have adhesive material to adhere the test strip to the diaper.

FIGS. 6B and 6C show example test strips with multiple testing areas according to certain example embodiments. In FIG. 6B, test strip 620 includes conductive lengths 622 and a testing area that is divided into multiple sub-test areas 623, 624, 626, and 630. Each of sub-test areas 623, 624, 626, and 630 include a corresponding test that reacts to a liquid or other substance that is applied to the respective sub-test area. For example, sub-test area 623 may change to blue for a particular test, while sub-test area may change to red (e.g., one may test glucose and other may test ph levels).

In FIG. 6C a portion of a test strip 650 is shown with a multi-part testing area and a dedicated area 656 with bar 654 that indicates the number of tests on the test strip 650. While the dedicated area 656 is located on the right in FIG. 6C, it will be appreciated that it may be positioned elsewhere on the test strip. Bar 654 of the dedicated area 656 corresponds to the number of tests included with strip 650. In this example, bar 654 is half of dedicated area 656 and corresponds to a test strip that has 4 tests.

In certain examples embodiments, the diaper tag may optically obtain information regarding test area 652 and/or dedicated area 656 to determine the number of tests on the installed strip 650. The diaper tag may then send the details of the strip to a server for verification. For example, the diaper tag may send “04” to the server indicating that the installed test strip has 4 different tests.

Thus, if a physician ordered multiple tests to be performed on a certain patient, that information may be made available by a central server and matched to the information received from the diaper tag regarding the number of tests on the installed strip. In other words, the two pieces of data may be compared and if there is no match (e.g., the physician ordered a 2 test strip, but a 4 test strip is installed) an alert may be generated and sent to a designated staff member.

In certain example embodiments, each test type may be associated with a unique identifier (e.g., GUID) and each instance of that particular test type may have the unique identifier placed on a corresponding test strip. For example, the dedicated area 656 may hold the GUID or other encoded value. In certain examples, the GUID may be in the form of a bar code or the like. Information corresponding to a particular test type (e.g. number of tests, delay factors, etc) may be stored in a database or other computing resource. This information may be sent to the diaper tag so that the test strip may be implemented in accordance with these variables (e.g., number of tests to determine, delay values, number of images to obtain, etc).

FIG. 7 is a perspective view of another example diaper tag 700, which has a camera hole 702 and an associated imager placed away from the rotational axis or proximal edge 704 of the diaper tag 700 than the imager of diaper tag 500. Specifically, the camera is placed at “lower” on the diaper tag and closer from the distal edge 706 of the diaper tag 700. Such placement may be used, for example, when the diaper tag is used in combination with a diaper with an imaging window.

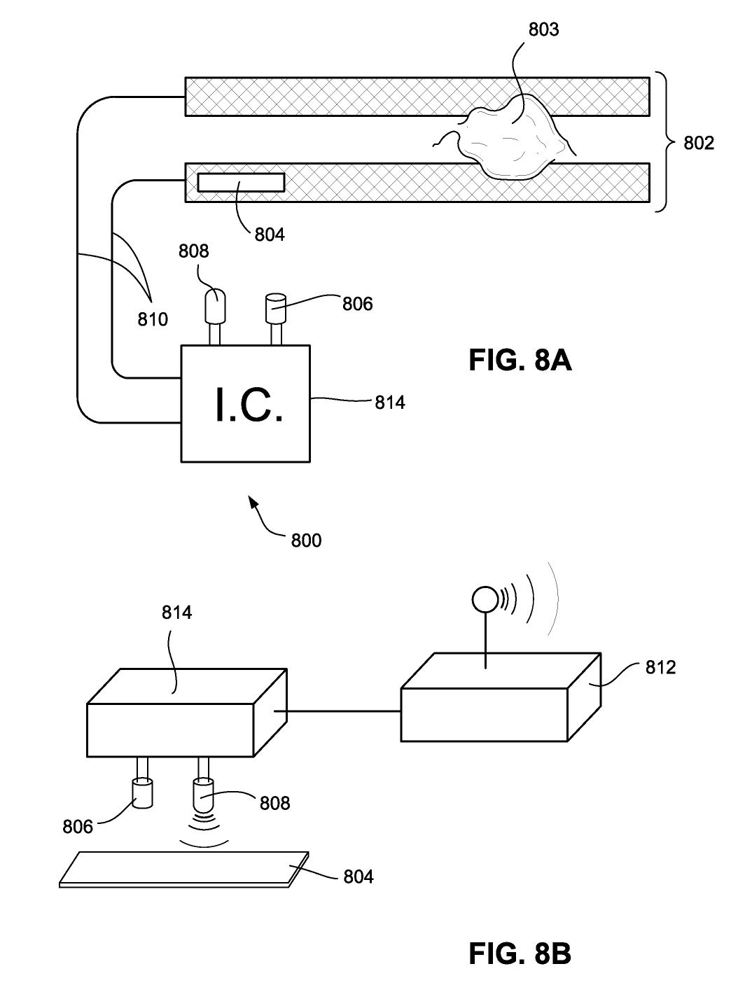

FIGS. 8A and 8B are block diagrams of an example diaper tag and test strip according to certain example embodiments. Diaper tag 800 includes an integrated circuit (IC) or processor 814 (e.g., possibly part of an RFID chip) that is in electrical communication with conductive lengths 802 of an example test strip via conductive connections 810. The conductive connections 810 and conductive lengths 802 may be short circuited when a liquid 803 (e.g., urine) or other electrically conductive substance bridges a gap between the conductive lengths 802. The electrically conductive connections 810 may be realized, at least in part, as conductive elements 508 and/or 514 of the diaper tag in FIG. 5.

The processor 814 is coupled to camera 806 and LED light source 808. Camera 806 is positioned so as to obtain an image of testing area 804 of an example test strip via a detection window. In this example, the testing area 804 (or a part of the testing area) may be provided via an aperture between conductive lengths 802. In certain example embodiments, the testing area may be placed between the conductive lengths. In other words, it will be appreciated that various configurations and placements of the conductive length(s) and the testing area may be realized.

As the diaper tag may be designed to operate with a test strip in a diaper worn by a user, the LED light source 808 provides illumination to the testing area 804 in conjunction with the camera 806 sp as to obtain a picture of the testing area 804. When an image is to be acquired by the camera, the surface of the test strip may be automatically illuminated with LED light source 808 in order to obtain a clearer and more accurate image of the testing area of the test strip. In certain example embodiments, the triggering of the LED light and camera may be caused by an associated wetness sensor detecting the presence of liquid in the diaper (e.g., detecting a short between conductive lengths 802).

An RF transmitter 812 (or transceiver in certain instances) is coupled to processor 814 and configured to wirelessly transmit a test result to remote a computing resource (e.g., a central server or the like via a wireless receiver). In certain example embodiments, the test result may be the image acquired by the camera, or test result data determined from such an image. That is, in certain example embodiments, the processor 814 may itself be configured to perform localized processing on the image to determine test results. The result of this processing may then be transmitted via transmitter 812.

In certain example embodiments, the transmitter and/or processor may be, or include, an RFID device. For example, the diaper tag may include an image analysis RFID circuit with an on-board processor which can be programmed to analyze any result from either an analog or digital device and then transmit the result to a central server. In certain examples, once a new image is acquired or created it is immediately analyzed by software and/or hardware. The analysis result also may be saved into the RFID chip on the diaper tag (e.g., for later transmission).

The RFID device may be passive or active. In certain example embodiments, a passive RFID device may be used, in conjunction with an activating reader located nearby, to trigger a detection process to determine if a conductive circuit has been shorted, and, if so, to acquire an image, analyze the image to generate a result, and transmit a result. That is, in certain example embodiments, a passive RFID circuit processor for determining a short, camera, and/or transmitter may be temporarily powered by electromagnetic induction (e.g., charged by a capacitor) that is generated by a local RFID reader/transmitter/exciter. In certain examples, the diaper tag may include an active RFID circuit using a local on-board battery to provide power for components requiring more power than is available via electromagnetic induction. With a passive RFID circuit electromagnetic induction may periodically charge a capacitor that is used as temporary power to determine if a short in the conductive circuit has yet occurred (e.g., if the test strip has been activated). If the strip has been activated, then a local battery may provide power to a camera, further processor (e.g., use to analyze an image), transmitter, or the like if needed. It will be appreciated that other combinations of how or what components are actively powered by a local battery may be realized.

In certain example embodiments, a transmitted test result (e.g., after analysis processing) may be a string of 16 characters representing a vendor, test type, and/or test result. Other required or optional fields may be added according to certain example embodiments. For example, such information may include a user identifier or information concerning the person that the test is associated with, the model number of the diaper tag, additional raw information on the obtained image, etc.

As an example, a glucose level test by vendor ABC may have a determined test result of: “ABC 3233 H233B8276.” The first part of the string may correspond to the vendor (ABC) of the test, the second may correspond to the test type (3233), and the third string portion may correspond to the test result (H233B8276). It will be appreciated that other encoding techniques may be used in order to translate an obtained image into a different test data formats (e.g., the result may be based on binary values rather than ASCI-coded characters or the like).

In certain example embodiments, the analysis of the acquired image may detect the color, shape, or both color and shape of the test portions of the test strip. For example, one type of test on a test strip may present a particular shape when the associated test is successful or has certain predetermined results. In certain example embodiments, a test may have different levels where the intensity or color corresponds to a level associated with a particular chemical (e.g., a glucose level).

In certain example embodiments, the structure of the test result may be flexibly modified by a central server. For example, the encoding of the string on the diaper tag may be updated (e.g., if the diaper tag includes an RF transceiver rather than just a transmitter) as needed based on the type of test strip being used with a diaper tag.

In certain example embodiments, the diaper tag and the transmitter may repeatedly (e.g., periodically) transmit a beacon or status value to the central server. This beacon may indicate to the central system that the diaper tag is functional and standing by. The beacon may provide information that indicates the diaper tag is low on battery power, that a test strip is not currently in the diaper (e.g., because no conductive connection has been formed), and the like.

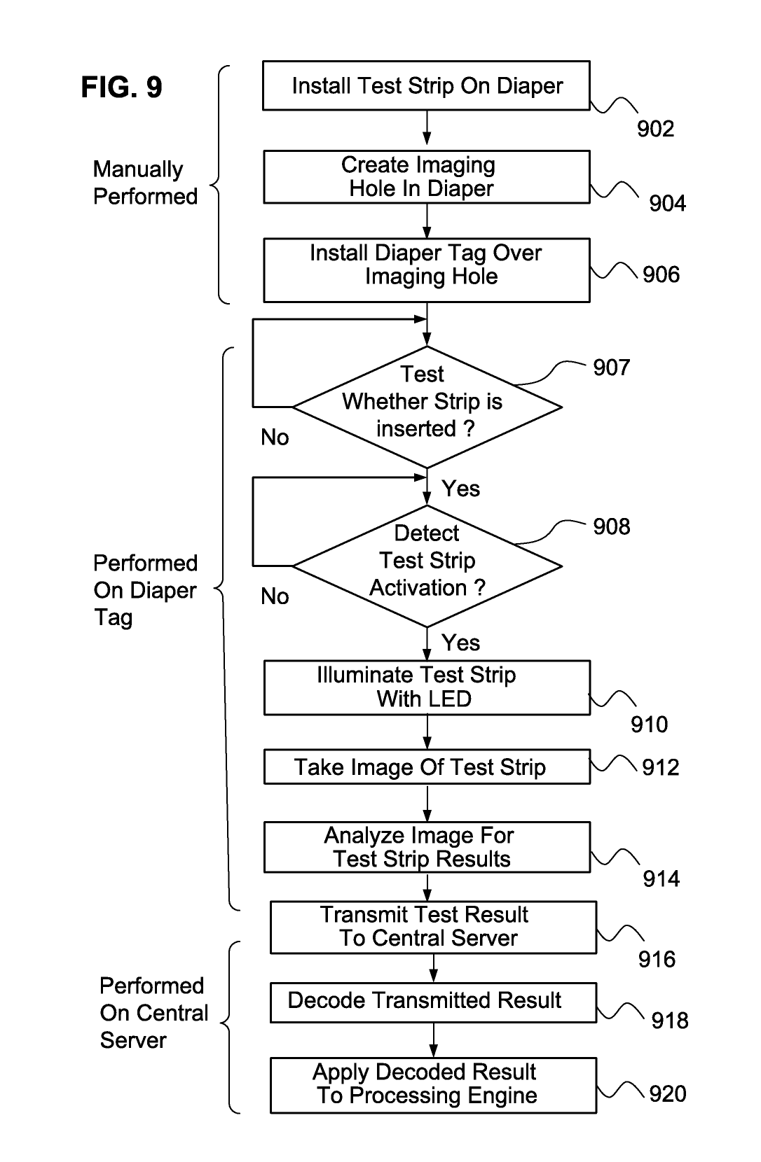

FIG. 9 is a flow chart of an example process for acquiring a test result from a test strip according to certain example embodiments. As noted herein, certain example embodiments allow for modification of off-the-shelf diapers in conjunction with example test strips and/or diaper tags according to certain example embodiments. Thus, in step 902 a person (e.g., a medical professional, the person to wear the diaper, etc) may install or otherwise attach a test strip on an inner layer of the diaper. The test strip may be precut for a particular size of diaper or may be a large continuous roll such that the person may cut different segment lengths. During this installation process, the portion of the test strip to be imaged may be placed so as to be in optical communication with the camera of the diaper tag.

In step 904 an imaging window or hole may be created in the diaper. In certain examples, a diaper may already include a hole when the user installs the test strip. For example, the diaper may be initially manufactured with such a hole.

In step 906, a diaper tag is attached to the diaper and placed over the window or hole such that the camera of the diaper tag is aligned with the window. As explained above, the imaging window may allow a camera located outside of the diaper to acquire an optical image of the test portion of the test strip that is inside the diaper. In particular, placement of the camera (and its thicker body portion) on the outside of the diaper may be more feasible and/or comfortable for the person wearing the diaper.

In certain example embodiments, there is no hole created or already provided in the diaper. Instead, a small portion of the test strip may extend beyond an edge of the diaper. In this case, the diaper tag may be attached to the diaper where the camera of the diaper tag is aligned with the test portion that is exposed outside and beyond the edge of the diaper. In certain instances, such a configuration may require less setup work on the part of medical professionals and thus may be preferable.

In any event, with the diaper, test strip, and diaper tag in place the diaper may be put into use by a person. As shown in FIG. 9, the installation of the test strip 902, creation of the imaging window or hole 904, and the placement of the diaper tag 906 may be a manually performed. However, one or more of these steps may be automatically performed (e.g., by a machine). For example, a machine may be configured to create the imaging window on each diaper in a set of diapers that are presented on a conveyor belt or the like. In certain examples, a machine may install the test strip and/or diaper tag.

In step 907 a test is performed (e.g., on the diaper tag) to determine if a test strip is in communication (e.g., inserted) with the diaper tag. If no strip is presented, “No,” then the process loops around and continues to check for the presence of a test strip. However, if a test strip is present, the process proceeds to step 908.

Once the diaper is placed in use (e.g. worn by a person), then in step 908, a determination is made as to whether the test strip has been activated. In certain example embodiments, this determination may include detecting wetness within the diaper through the use of conductive lengths that are part of the test strip. Other types of detections (manual or automatic) may also be used. For example, the camera in the diaper tag may continually acquire images to determine if there is a change in state of the testing portion. If no change in state of test strip is present or detected, the acquired image may simply be discarded. However, if a change in state is detected, then the test results are available as an image, which may be used for further analysis or a higher quality image of the testing area of the test strip may now be acquired.

In certain examples, a determination as to whether a test strip has been activated may be based on a remote trigger. For example, as described herein, an RFID device may be installed on the diaper tag. This device may receive communication or be “excited” by a nearby reader/exciter. As result of being excited, an electrical resistance measuring process may be initiated that determines if the test strip has been activated.

The determination as to test strip activation may be continually performed (“No”) until a successful or positive determination is made (“Yes”).

After detecting that the test strip has been activated, an LED light on the diaper tag may be triggered to illuminate a testing area of the test strip in step 910. Concurrently with, or just after, such illumination is initially presented, in step 912, the camera or imager on the diaper tag acquires an image of the test portion of the test area.

In certain examples, after detecting wetness on the test strip (e.g., step 908), the diaper tag may wait a certain length of time before scanning the test strip for test results. Such a time delay value may be set from a remote computing device (e.g., the central server). In certain instances, the delay time factor may be encoded on the test strip and initially determined by the diaper tag (e.g., in step 907). In certain examples, the delay value may vary depending on the strip type.

Multiple different scans of the strip may be performed. For example, a first scan may be performed one minute after wetness detection, a second scan five minutes after, and a third scan ten minutes after. Accordingly, multiple images may be acquired at different time periods. In certain example embodiments, the frequency and/or number of images to acquire may be received from a remote computing resource (e.g., a central server) and set by the diaper tag.

In step 914, a local processor in the diaper tag performs an image analysis process to determine test strip results for the image. In step 916, the test result is transmitted to a central server.

As shown in FIG. 9, steps 908-916 may be steps that are performed on an example diaper tag. However, certain steps may be performed elsewhere. For example, the acquired image may be sent to a remote computing resource for processing. In other words, instead of sending a result of analyzing the image, the diaper tag may transmit the acquired image.

The next two steps, 918 and 920, may be performed on a remote computing resource or a central server system.

In step 918, the central server or system receives the transmitted test result and decodes the result. For example, the above discussed string is decoded to determine vendor, test type, and test result information.

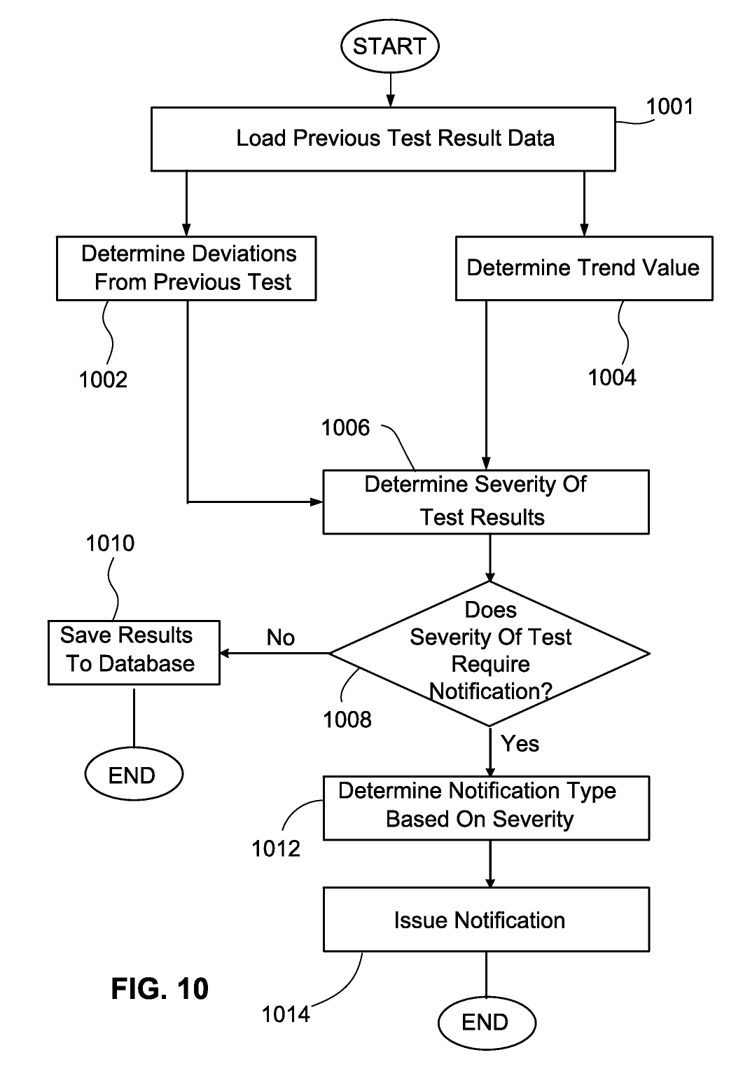

In step 920, the decoded result is sent through a processing engine to determine what action should be taken based on the determine test result. The processing engine is discussed in more detail with the process shown in FIG. 10.

As discussed above, in certain example embodiments, instead of performing localized analysis processing on the diaper tag, the image analysis processing may be performed on the centralized server. In other words, instead of sending an analyzed testing result, the obtained image (or a partial portion thereof) may be sent to the central server for analysis.

It will be appreciated that the order of steps in these example processes may be adjusted (e.g., by switching the order of steps 902 and 904). Additionally, it will be appreciated that certain steps may be omitted (e.g., step 904 or 902). For example, the diaper may come with a test strip pre-installed or already integrated into the diaper.

FIG. 10 is a flow chart of an example process for processing a test result according to certain example embodiments. After starting or initializing, in step 1001, the process loads previous test result data for the patient/user that is associated with the recently received test result data. The loaded data may include past individual test results or aggregated past test results for that user.

In step 1002, the processing engine determines if the decoded test result from the diaper tag is a material deviation from a previous test result. For example, the immediately prior test result is checked against the current test result. In step 1004, the processing engine also may determine if the current test result has materially deviated from (or is inline with) an overall longer trend of test results for that user. In certain example embodiments, this may include determining if the current test result pushes an ongoing trend over a certain threshold value. Such information may be used to determine if a patient is improving or not.

In step 1006, based on the analysis in steps 1002 and 1004, a severity level may be assigned to the new test result. In step 1008, the system determines if the assigned severity level requires notification to one or more persons. If no notification is required, then in step 1010, the test result is saved to a database, file, or the like for future use (e.g., indefinitely) and this instance of the process ends by exiting to a calling process, program, operating system, or the like.

In step 1012, if a notification is required, the type of notification is determined. This determination may include determining who to notify (e.g., doctor, nurse, other staff, the patient, etc) and how that person should be notified (e.g., email, page, telephone call, alarm, etc). Once this information is determined, then in step 1014 the notification may be issued and this instance of the process ends by exiting to a calling process, program, operating system, or the like.

The following is an example analysis logic that may be used by a decision making engine (implemented on a computing system) to decide what further actions are to be executed based on an obtained test result according to certain example embodiments:
1. Any change (e.g. a material change) in a test result from previous tests may result in alerts to the designated staff.
2. Any detected trend in result level such as rising glucose levels over time may also be brought to the attention of designated staff members.
3. A sudden extreme change in results may initiate a critical alert to designated staff.
4. Alerts may be sent in electronic methods such as e-mail, text, and/or voice.
5. According to the test results fluctuation from previous tests, each result may be given a different priority/importance level which in turn can trigger different alerts
Example Importance levels may be:
   Level-1 Normal—Save test records in patient/resident file.
   Level-2 Attention Required—Save test records in patient/resident file, light an LED on the tag of the patient.
   Level-3 Important—Save test records in patient/resident file and notify medical staff by test & Email.
   Level-4 Critical—Save test records in patient/resident file, notify medical staff by text (e.g., SMS) and e-mail, call on-call medical staff and request a confirmation.
   In certain examples, the importance/priority levels may be saved on the on-board RFID chip.

In certain example embodiments, the diaper tag may communicate with a personal and/or mobile computing device. For example, the diaper tag may communicate with a smart phone, tablet computer, laptop, desktop, beeper, or the like. For example, the diaper tag may be used in a home environment for monitoring a baby with a diaper. The diaper tag may wirelessly communicate with a computing device of the parents of the child. The processing described herein may be carried out on the user's personal device without the need for a central server. In certain example embodiments, user's may use their mobile phones to directly communicate (transmit and receive) information from/to the diaper tag. The information may include what test are to be performed (e.g., based on an installed diaper strip) or what actions should be taken based on received test results. Wireless communication may be performed via Bluetooth, Wi-Fi, RFID, near field communication techniques, and the like.

In certain examples, multiple diaper tags may be used to monitor many patients in large environments such as a hospital or care facility. In certain example embodiments a single diaper and corresponding diaper tag can be used to monitor a baby in or other person in a home. Diaper tags may be structured in different shapes and/or sizes and be attachable to any size or type of types worn by babies to adults.

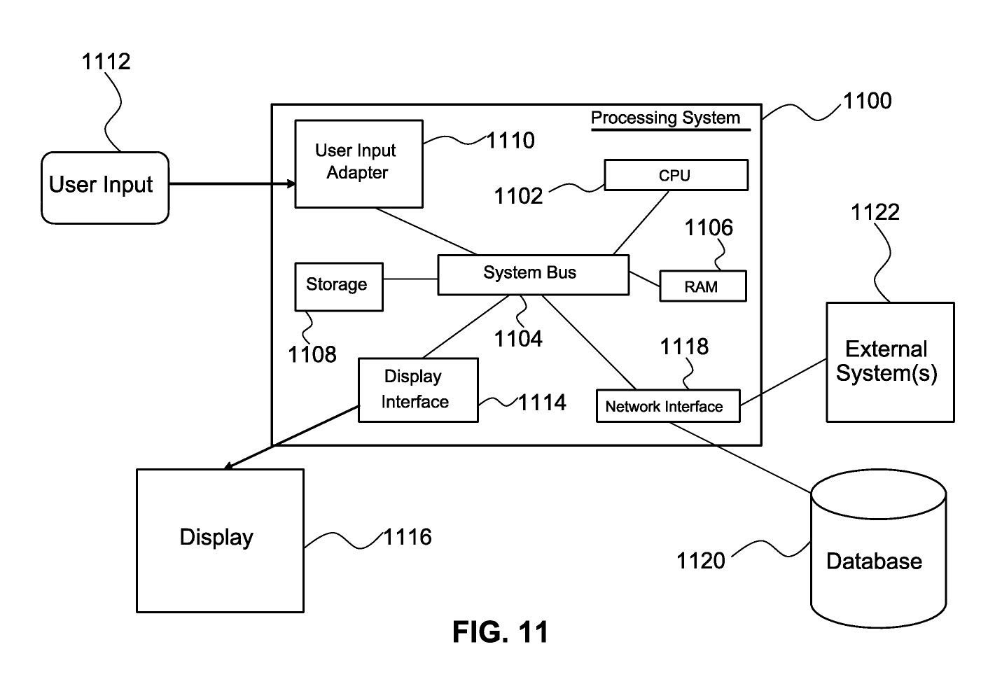

FIG. 11 is a block diagram of an exemplary computing system according to certain example embodiments. A processing system 1100 includes a central processing unit or CPU 1102, a system bus 1104 that communicates with RAM 1106, and storage 1108. The storage 1108 can be magnetic, flash based, solid state, or other storage technology. The system bus 1104 may also communicate with a user input adapter 1110 (e.g., PS/2, USB interface, or the like) that allows users in input commands to the processing system via a user input device 1112 (e.g., a keyboard, mouse, touch panel, or the like). The results of the processing may be displayed to a user on a display 1116 via a display interface 1114 (e.g., a video card or the like).

The processing system 1100 may also include a network interface 1118 that may facilitate wired (e.g., Ethernet) or wireless communication (Wi-Fi/802.11x protocols, cellular technology, and the like) with external systems 1122 or databases 1120. External systems 1122 may include other processing systems, systems that provide third party services, etc.

As described herein, external systems 1122 may include example diaper tags (and the associated components therein) or a central server system. Additionally, the processing system 1100 may implement functionality as a central server system (e.g., where the external system is a diaper tag). Further, a processor included in an example diaper tag may include some (or all) of the components of processing system 1100. For example, the network interface may provide the transmitter (or transceiver) of the diaper tag.

External systems 1122 may include other types of computing systems such as, for example, network attached storage (NAS) that holds large amounts of data (e.g., thousands or millions of electronic documents/records). Such external systems for storage, along with the internal storage and memory, may form a storage system for storing and maintaining information on the test results of one or more patients (e.g., thousands of patients). Such a system many communicate with certain users and respective computing resources (e.g., a client system, terminal, etc) to provide test results and associated analysis for review and consideration.

The database 1120 may include relational, object orientated, or other types of databases for storing information (e.g., such as test results obtained from diaper tags).

In other words, the processes, techniques, and the like, described herein are, at least in part, implemented by a computing system. Such implementations include configurations (executable computer program code structures—e.g., sometimes referred to as software) of processing systems to carry out certain aspects of example embodiments.

Certain examples herein are described in terms of sequences of actions that can be performed by, for example, elements of a programmable or programmed computer system. It will be recognized that various actions also could be performed by specialized circuits (e.g., discrete logic gates interconnected to perform a specialized function or application-specific integrated circuits—ASIC), by program instructions executed by one or more processors, or by a combination of both.

Moreover, portions of the example embodiments can also be considered as embodied entirely within any form of non-transitory computer-readable storage medium (e.g., RAM, ROM, so-called hard drives, portable media—DVDs, etc) having stored therein an appropriate set of computer readable or executable instructions for use by or in connection with an instruction-execution system, apparatus, or device, such as a computer-based system, processor-containing system, or other system that can fetch instructions from a medium and execute the instructions.

Thus, the invention may be embodied in many different forms, not all of which are described above. It will be appreciated that the techniques described herein may be applied to a variety of different contexts. For example, while some examples herein may be in a hospital or formal medical setting, the techniques and embodiments herein also may be applied in a home environment.

While certain embodiments herein include a camera, imager, or other optical sensor, other types of sensors may be used to acquire information from a tests strip. For example, a diaper tag may include ultrasonic sensors and/or capacitive sensors to acquire information from a test strip.

While the technology herein has been described in connection with what is presently considered to be preferred embodiment, it is to be understood that the invention is not limited to the disclosed embodiment, but on the contrary, is intended to cover modifications and equivalent arrangements as now will be apparent to those skilled in the art and as included within the spirit and scope of the claims.

What is claimed is:

1. A diaper analysis system for testing liquid deposited therein by a wearer, the system comprising:
a diaper having an inner surface configured to receive liquid from the wearer;
a test strip disposed for exposure to said liquid and having a test portion disposed proximate an outer edge of the diaper;
a housing configured for removable attachment to the outer edge of the diaper and in optical communication with the test portion disposed proximate the outer edge;
an imager carried by the housing and oriented towards said test portion when the housing is attached to the diaper, the imager being configured to obtain an image of the test portion; and
a wireless transmitter carried by the housing, the transmitter coupled to the imager and configured to transmit the obtained image or an analysis result based on the obtained image.

2. The diaper analysis system of claim 1, wherein the housing is configured to attach to the diaper by clamping onto the diaper, the housing including a first housing portion and a second housing portion that sandwich the test portion therebetween when the housing is clamped to the diaper.

3. The diaper analysis system of claim 2, wherein the first housing portion interfaces with the inner surface of the diaper and the second housing portion interfaces with an outer surface of the diaper when the housing is clamped to the diaper.

4. The diaper analysis system of claim 3, wherein the first and second housing portions are rotatable with respect to each other along an axis of rotation.

5. The diaper analysis system of claim 2, wherein:
the imager is carried by the second housing portion,
when the housing is clamped to the diaper, an imaging window through the diaper is located between the test portion and the second housing portion.

6. The diaper analysis system of claim 2, wherein:
the test portion of the test strip extends beyond the outer edge of the diaper, and
when the housing is attached to the diaper, the test portion is located between the outer edge of the diaper and an axis of rotation for the first and second housing portions.

7. The diaper analysis system of claim 6, wherein said test portion is structurally stronger than another portion of the test strip.

8. The diaper analysis system of claim 1, wherein the housing further comprises a wetness sensor configured to detect wetness applied to the test strip.

9. The diaper analysis system of claim 8, wherein the wetness sensor includes conductive elements carried by the test strip.

10. The diaper analysis system of claim 1, wherein
the diaper includes a front portion configured to be oriented to the front of the wearer and a rear portion, and
the test strip extends towards and to the rear portion of the diaper and the housing attaches to the rear portion of the diaper.

11. The diaper analysis system of claim 1, further comprising a light source carried by the housing and configured to illuminate the test portion while the imager obtains the image.

12. The diaper analysis system of claim 1, further comprising at least one processor carried by the housing, the at least one processor being configured to generate the analysis result based on the obtained image,
wherein the analysis result includes data identifying a vendor, at least one test result, and a test type.

13. The diaper analysis system of claim 1, in combination with a remote computing system that includes at least one processor, the remote computing system being configured to:
receive the analysis result;
assign a severity level to the analysis result; and
transmit a notification based on the assigned severity level.

14. The diaper analysis system of claim 13, wherein the remote computing system is further configured to:
compare the received analysis result with at least one prior analysis result for the same wearer,
wherein the assigned severity level is further based on the comparison.

15. The diaper analysis system of claim 1, wherein the test strip carries multiple different tests.

16. The diaper analysis system of claim 15, wherein at least one of the multiple different tests is located outside of the test portion.

17. The diaper analysis system of claim 15, wherein the test portion includes two or more different tests.

18. A testing apparatus for attachment to a diaper including a test strip carried by an inner surface of the diaper and having a test portion configured to react with a substance deposited by a wearer, the apparatus comprising:
a housing removably attachable to the diaper and configured to attach to the diaper where the test portion is located;
an optical sensor carried by the housing and configured to acquire an image of at least part of the test portion; and
a wireless transmitter configured to transmit a test result to a remote computing system based on the acquired image.

19. The testing apparatus of claim 18, wherein:
the housing comprises a first housing portion and a second housing portion that sandwich the imaged test strip part when the housing is attached to the diaper, the first and second housing portions being rotatable with respect to each other about a rotational axis of the housing,
wherein the first housing portion is located at least partially inside the diaper and the second housing portion is located outside the diaper.

20. The testing apparatus of claim 19, wherein the optical sensor is carried by the second housing portion.

21. The testing apparatus of claim 20, wherein, when the housing is attached to the diaper, the housing encompasses an imaging window located between the imaged test strip part and the second housing portion, the optical sensor having optical access to imaged test strip part via the imaging window.

22. The testing apparatus of claim 18, wherein:
the test portion of the test strip extends beyond an edge of the diaper, and
the imaged test strip part of the test portion is located between the diaper edge and a rotational axis of the housing.

23. The testing apparatus of claim 18, further comprising:
a wetness sensor configured to interface with a conductive element of the test strip to detect when liquid is applied to the test strip,
wherein the optical sensor is further configured to obtain the image in response to the wetness sensor detecting liquid.

24. The testing apparatus of claim 18, further comprising:
a light source configured to illuminate the imaged part of the test strip while the optical sensor acquires the image.

25. The testing apparatus of claim 18, further comprising:
at least one processor connected to said optical sensor and configured to generate the test result based on the acquired image,
wherein the test result includes information identifying a vendor, a result, and a test type.

26. The testing apparatus of claim 18, wherein the test result includes the acquired image or an image based on the acquired image.

27. A method of analyzing a liquid captured by a diaper that includes a test strip carried by an inner surface of the diaper, the diaper having an attached sensor, the attached imager having an imaging view of a testing portion of the test strip, the method comprising:
detecting application of liquid to the test strip carried by the diaper;
acquiring, via the sensor also carried by the diaper, at least one image of the testing portion of the test strip responsive to detecting application of the liquid;
generating, via at least one processor also carried by the diaper, a test result that is based on the acquired at least one image; and
wirelessly transmitting the test result from diaper-carried components, to a remote computing resource.

28. The method of claim 27, wherein the test strip, including the testing portion, extends beyond an edge of the diaper.

29. The method of claim 27, wherein the diaper has an imaging window formed therethrough, with the testing portion of the test strip located on an inner side of the imaging window and the attached sensor located on an outer side of the imaging window.

30. The method of claim 27, further comprising:
determining, via at least one processor of the remote computing resource, a severity level for the test result; and
transmitting, via the remote computing resource, an alert based on the severity level.
